(19) United States
(12) Patent Application Publication
(10) Pub. No.: US 2026/0147508 A1
(43) Pub. Date: May 28, 2026

(54) STORAGE DEVICE, MEMORY CONROLLER, AND METHOD OF ACCELERATING SUSTAINED STATUS

(71) Applicant: Samsung Electronics Co., Ltd., Suwon-si (KR)

(72) Inventors: Kyounghweon Lee, Suwon-si (KR); Sangho Yi, Suwon-si (KR); Jinhwa Lee, Suwon-si (KR)

(21) Appl. No.: 19/369,772

(22) Filed: Oct. 27, 2025

(30) Foreign Application Priority Data
Nov. 22, 2024 (KR) 10-2024-0168917

(51) Int. Cl. G06F 3/06

(52) U.S. Cl. CPC G06F 3/0659; G06F 3/0604; G06F 3/0679

(57) ABSTRACT

An example method for accelerating a sustained status of a storage device includes receiving a sustained status command, in response to the sustained status command, generating distribution data for a target number of valid mapping units per memory block in the non-volatile memory based on configuration information for a sustained status mode included in the sustained status command, and entering into a sustained status mode by writing dummy data into a memory block in units of mapping units based on the distribution data, wherein the sustained status mode indicates a state in which the number of valid mapping units of memory blocks in the non-volatile memory corresponds to a target number of pieces of the distribution data.

### CROSS-REFERENCE TO RELATED APPLICATION

This application claims priority under 35 U.S.C. § 119 to Korean Patent Application No. 10-2024-0168917, filed on Nov. 22, 2024, in the Korean Intellectual Property Office, the disclosure of which is incorporated herein in its entirety by reference.

### BACKGROUND

Typically, to form a sustained status in a storage device, a method of inducing garbage collection for a long period of time through user workload is used. However, this method requires a very long precondition time to achieve the sustained status.

A previously proposed method to solve this problem is to form a sustained status based on the workload of a host, but this method is heavily dependent on the performance of the host.

### SUMMARY

The present disclosure relates to a storage device that quickly reach a sustained status without relying on the performance of a host, a memory controller, and a method of accelerating a sustained status.

In general, according to some aspects, a method of accelerating a sustained state of a storage device including a non-volatile memory and a memory controller controlling the non-volatile memory includes receiving a sustained status command, in response to the sustained status command, generating distribution data for a target number of valid mapping units per memory block in the non-volatile memory based on configuration information for a sustained status mode included in the sustained status command, and entering into the sustained status mode by writing dummy data into a memory block in units of mapping units based on the distribution data, wherein the sustained status mode indicates a state in which the number of valid mapping units of memory blocks in the non-volatile memory corresponds to a target number of pieces of the distribution data.

In general, according to some aspects, a storage device includes at least one non-volatile memory device and a memory controller configured to control the non-volatile memory, wherein the memory controller receives a sustained status command, in response to the sustained status command, generates distribution data for a target number of valid mapping units per memory block in the non-volatile memory based on configuration information for a sustained status mode included in the sustained status command, and cause the non-volatile memory to enter the sustained status mode by writing dummy data into the non-volatile memory in units of mapping units based on the distribution data, and the sustained status mode indicates a state in which the number of valid mapping units of memory blocks in the non-volatile memory corresponds to a target number of pieces of the distribution data.

In general, according to some aspects, a memory controller for controlling at least one non-volatile memory includes a sustained status acceleration module, the sustained status acceleration module is configured to receive a sustained status command, in response to the sustained status command, generate distribution data for a target number of valid mapping units per memory block in the non-volatile memory based on configuration information for a sustained status mode included in the sustained status command, and cause the non-volatile memory to enter the sustained status mode by writing dummy data into the non-volatile memory in units of mapping units based on the distribution data, and the sustained status mode indicates a state in which the number of valid mapping units of memory blocks in the non-volatile memory corresponds to a target number of pieces of the distribution data.

### BRIEF DESCRIPTION OF THE DRAWINGS

Implementations of the present disclosure will be more clearly understood from the following detailed description taken in conjunction with the accompanying diagrams.

FIG. 1 is a block diagram showing an example of a storage system.

FIG. 2 is a block diagram showing an example of a storage device.

FIG. 3 is a diagram illustrating an example of a FILL operation and an example of a FLUSH operation.

FIG. 4 is a block diagram showing an example of one non-volatile memory device (NVM).

FIG. 5 is a flowchart showing an example of a method of accelerating a sustained status of a storage device.

FIG. 6 is a flowchart illustrating an example operation S120 of the method of accelerating a sustained status of a storage device.

FIG. 7 is a diagram showing an example of a method of setting an average value, a maximum value, and a minimum value of a target number of valid mapping units per memory block.

FIG. 8 is a flowchart illustrating an example operation S130 of the method of accelerating a sustained status of a storage device.

FIG. 9 is a block diagram showing an example of a solid state drive (SSD).

FIG. 10 is a block diagram showing an example of a universal flash storage (UFS) system.

FIG. 11 is a block diagram showing an example of a data server system.

### DETAILED DESCRIPTION

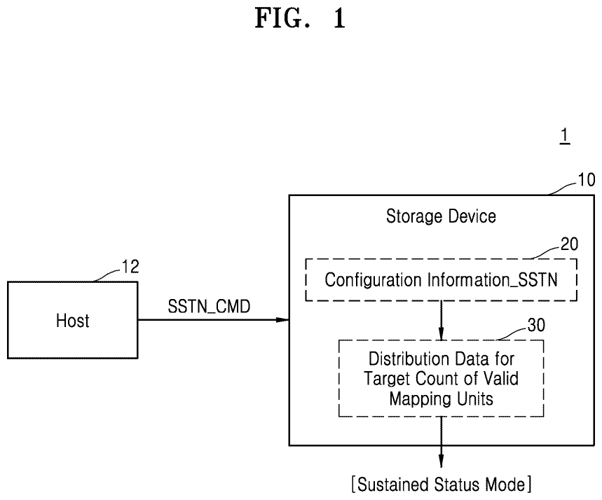

FIG. 1 is a block diagram showing an example of a storage system.

Referring to FIG. 1, a storage system 1 may include a storage device 10 and a host 12.

For example, the storage system 1 may be included in any one of a computer, a portable computer, an Ultra Mobile PC (UMPC), a workstation, a data server, a net-book, a personal digital assistant (PDA), a portable computer, a web tablet, a wireless phone, a mobile phone, a smart phone, a digital camera, a digital audio recorder, a digital audio player, a digital picture recorder, a digital picture player, a digital video recorder, a digital video player, a device capable of transmitting and receiving information in a wireless environment, and various electronic devices constituting a home network.

The host 12 may be configured to control the operation of the storage system 1. The host 12 may exchange information or data needed to run an operating system OS or a program with the storage device 10.

The storage device 10 may exchange data with the host 12 under the control of the host 12. For example, the storage device 10 may be a large-capacity storage medium used in the storage system 1, such as a hard disk, a solid state drive (SSD), a memory card, an embedded memory card, a memory stick, etc.

In some implementations, the storage device 10 may be implemented as a non-volatile memory device. For example, the non-volatile memory device may include a NAND flash memory, a vertical NAND flash (VNAND) memory, a NOR flash memory, and a resistive random access memory (RAM) (RRAM), a phase-change RAM (PRAM), a magnetoresistive RAM (MRAM), a ferroelectric RAM (FRAM), a spin transfer torque RAM (STT-RAM), etc. Also, the non-volatile memory device may be implemented to have a 3-dimensional array structure. The present disclosure may be applied not only to a flash memory device in which a charge storage layer includes a conductive floating gate, but also to a charge trap flash (CTF) in which a charge storage layer includes an insulation layer. Hereinafter, it is assumed that the storage device 10 is a flash storage device implemented as a flash memory device.

The storage device 10 may enter a sustained status mode in response to a sustained status command SSTN_CMD. Here, the sustained status may mean that blocks (e.g., memory blocks) within the storage device 10 have a similar number of valid mapping units. In other words, the sustained status may refer to a state in which each block in the storage device 10 has a number of valid mapping units greater than or equal to a reference number. In some implementations, the reference number may be determined in advance. Also, according to the present disclosure, a sustained status mode for accelerating the sustained status may refer to a state in which the number of valid mapping units of memory blocks in a storage device corresponds to a target number of pieces of generated distribution data.

Here, the number of valid mapping units may refer to the number of physical mapping units in which valid data is stored in one memory block. Also, in some implementations, the number of valid mapping units may be referred to as a valid page count (VPC). The VPC originally stands for a valid page count, but it may also mean the number of units in which valid data is stored within a particular block or page. In other words, when the storage device 10 manages data by mapping units, the VPC may refer to the number of valid mapping units.

In this specification, a valid mapping unit refers to a physical mapping unit storing data to which a logical mapping unit number is assigned, and an invalid mapping unit refers to a physical mapping unit storing data to which a logical mapping unit number is not assigned (e.g., dummy data).

In the sustained status, all victim blocks subject to garbage collection may have similar numbers of valid mapping units. In other words, when all blocks have similar numbers of valid mapping units, blocks subject to garbage collection (i.e., victim blocks) will also have similar numbers of valid mapping units, and thus the load of garbage collection may be distributed. In other words, when the storage device 10 operates in a sustained status, since each block has a similar number of valid mapping units, an amount of valid mapping units that need to be moved in each block during garbage collection may also become similar. When performing garbage collection in a sustained status, since the deviations in numbers of valid mapping units of blocks selected as sources is not significant, the storage device 10 operating in a sustained status mode may maintain predictable and constant performance as valid mapping units of similar levels are copied. In other words, the deviation in numbers of valid mapping units generated by garbage collection is reduced, and thus constant performance may be maintained. This is an important factor in maintaining predictable and consistent write performance, and may prevent sudden performance degradation.

In general, the reason why the sustained status is important is because it is similar to the actual operating environment of data center products. The workload in a data center mainly includes random mixed I/O, and thus a storage device naturally reaches a sustained status. Therefore, the performance and quality of service (QoS) of data center products are typically evaluated in a sustained status. In other words, in a typical storage device, a write operation for several hours or days is needed while changing the data access pattern sequentially or randomly to form a sustained status.

On the other hand, the storage device 10 according to the present disclosure may quickly enter the sustained status mode without performing a garbage collection operation, in response to the sustained status command SSTN_CMD.

In other words, the storage device 10 according to the present disclosure may enter a sustained status mode in response to the sustained status command SSTN_CMD upon entering the sustained status mode, generate distribution data 30 regarding a target number of valid mapping units per memory block based on configuration information 20 regarding the sustained status mode, and accelerate the sustained status using generated distribution data 30. In some implementations, the storage device 10 may enter a sustained status mode by writing dummy data into a memory block in units of mapping units based on the distribution data 30.

Here, the configuration information 20 regarding the sustained status mode may be included in the sustained status command SSTN_CMD. The configuration information 20 regarding the sustained status mode is the minimum information for the storage device 10 to enter the sustained mode, and may include, for example, the total number of valid mapping units to be used in the sustained status mode, the number of memory blocks to be allocated to user data, the total number of memory blocks, the number of system blocks and minimum free blocks that need to be maintained for normal operation of firmware, the mapping size, the internal structure of a memory, the logical block address (LBA) format, and/or the firmware policy.

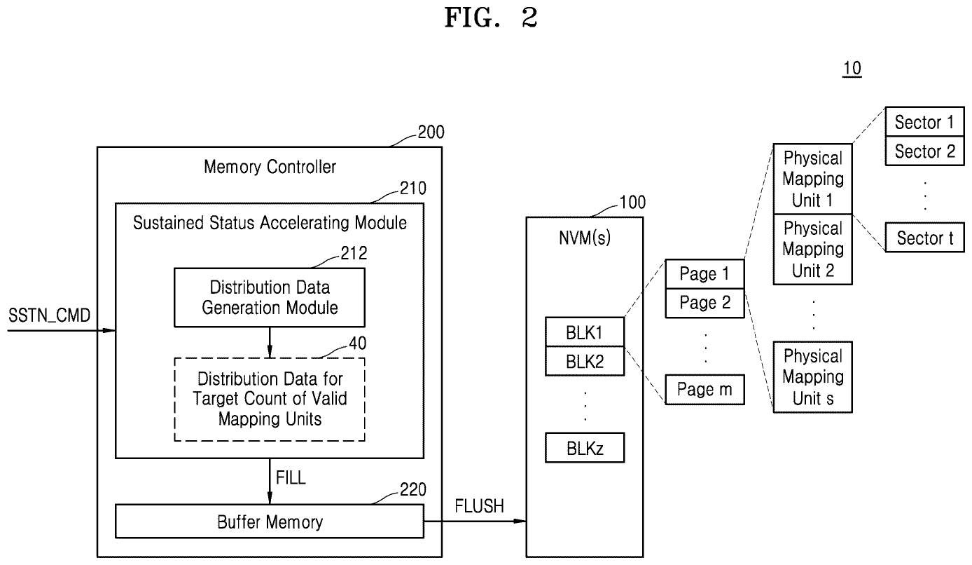

According to the present disclosure, a method of accelerating the sustained status of the storage device 10 will be described in detail with reference to FIGS. 2 to 8.

According to the present disclosure, entry of the storage device 10 into the sustained status mode may be implemented by the internal operation of the memory controller 200. In other words, since there is no data exchanged with the host 12 (FIG. 1) other than the sustained status command SSTN_CMD of the host 12 (FIG. 1) when the storage device 10 enters the sustained status mode, the storage device 10 according to the present disclosure may enter the sustained status mode with a constant performance regardless of the performance of the host 12 (FIG. 1).

According to the present disclosure, unlike the entry to the sustained status by the host workload or the firmware of the host 12, the entry to the sustained status according to the present disclosure does not rely on the host workload or the firmware of the host 12. Therefore, the memory controller 200 according to the present disclosure may be universally utilized in a storage device.

According to the present disclosure, entry to the sustained status mode of the storage device 10 may be implemented as an internal operation of the memory controller 200 without the need to extract a sustained valid page count or a valid mapping unit count from another storage device.

According to the present disclosure, since entry to the sustained status mode of the storage device 10 is performed inside the memory controller 200, the storage device 10 may write dummy data to a memory block in units of mapping units rather than in units of pages.

In the sustained status mode of the storage device 10 according to the present disclosure, dummy data is written to a memory block in units of mapping units rather than in units of pages, and thus the sustained status formed by the storage device 10 is more similar to a sustained status formed in an actual user environment than sustained status mode in units of pages. Therefore, the accuracy of a test result regarding the storage device 10 in the sustained status mode may be improved.

FIG. 2 is a block diagram showing an example of a storage device.

Referring to FIG. 2, the storage device 10 may include at least one non-volatile memory device 100 and the memory controller 200 that controls the at least one non-volatile memory device 100.

The non-volatile memory device 100 may include a plurality of memory blocks BLK1 to BLKz (z is an integer greater than or equal to 2). The plurality of memory blocks BLK1 to BLKz may each include a plurality of pages Page 1 to Page m (m is an integer greater than or equal to 2). The plurality of pages Page 1 to Page m may each include a plurality of physical mapping units Physical Mapping Unit 1 to Physical Mapping Unit s (s is an integer greater than or equal to 2). The plurality of physical mapping units Physical Mapping Unit 1 to Physical Mapping Unit n may each include a plurality of sectors Sector 1 to Sector t (t is an integer greater than or equal to 2).

Here, a memory block may be a unit for erasing data from the storage device 10. Also, a page may be a unit for writing to or reading data from the storage device 10. Also, a physical mapping unit may be the minimum unit used when mapping between a logical address and a physical address in one page of the storage device 10. A sector may be the minimum storage unit of data in the storage device 10. Also, one physical mapping unit may include a plurality of sectors. For example, when the storage device 10 uses a 512 byte LBA format and the size of one physical mapping unit is 4 KB, one physical mapping unit may include eight sectors each having the size of 512 bytes.

A sustained status acceleration module 210 may accelerate the sustained status of the storage device 10 in response to the sustained status command SSTN_CMD. The sustained status acceleration module 210 may be implemented as software, hardware, or a combination of hardware and software.

A buffer memory 220 may temporarily store data to be written to the non-volatile memory device 100. The buffer memory 220 may also be referred to as a write buffer. The memory controller 200 may perform a FILL operation and a FLUSH operation through the buffer memory 220. An operation of the memory controller 200 for temporarily storing a plurality of pieces of data in the buffer memory 220 to write the plurality of pieces of data to the non-volatile memory device 100 at once may be referred to as the FILL operation. An operation of the memory controller 200 to write a plurality of pieces of data temporarily stored in the buffer memory 220 to the non-volatile memory device 100 at once when the buffer memory 220 is full (flush-on-full) or after a certain period of time is elapsed (flush-on-demand) may be referred to as the FLUSH operation.

The sustained status acceleration module 210 may include a distribution data generation module 212.

The distribution data generation module 212 may generate the distribution data 30 for a target number of valid mapping units in the sustained status mode based on the configuration information 20 (FIG. 1) regarding the sustained status mode in response to the sustained status command SSTN_CMD.

Here, the configuration information 20 regarding the sustained status mode may be included in the sustained status command SSTN_CMD. The configuration information 20 regarding the sustained status mode is the minimum information for the storage device 10 to enter the sustained mode, and may include, for example, the total number of valid mapping units to be used in the sustained status mode, the number of memory blocks to be allocated to user data, the total number of memory blocks, the number of system blocks and minimum free blocks that need to be maintained for normal operation of firmware, the mapping size, the internal structure of a memory, the LBA format, and/or the firmware policy.

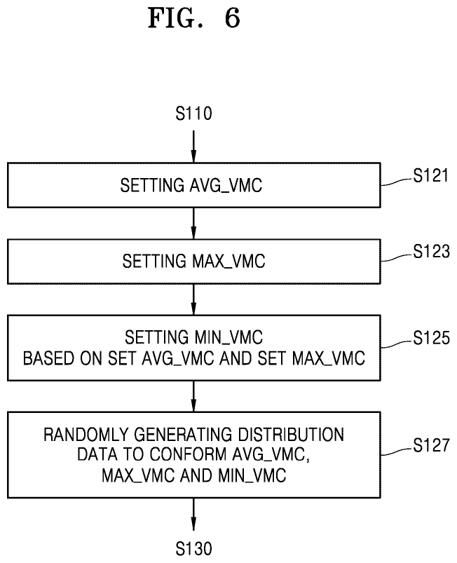

In detail, in response to the sustained status command SSTN_CMD, the distribution data generation module 212 may set a minimum value, a maximum value, and/or an average value of the number of valid mapping units per memory block in the sustained status mode based on the configuration information 20 regarding the sustained status mode. Detailed descriptions thereof will be given later with reference to FIG. 6.

In other words, to generate the distribution data 30 for the target number of valid mapping units, the distribution data generation module 212 may set a minimum value, a maximum value, and/or an average value for the number of valid mapping units per memory block for memory blocks, which are targets of a write operation to enter a sustained status from among a plurality of memory blocks BLK1 to BLKz.

Also, the distribution data generation module 212 may arbitrarily generate the distribution data 30 for the target number of valid mapping units per memory block, such that the target number of valid mapping units per memory block conforms to a set minimum value, a set maximum value, and an average value. Here, the distribution data 30 may correspond to a set of the number of valid mapping units per memory block for the memory block that is the target of a write operation to enter a sustained status.

In other words, the distribution data generation module 212 may arbitrarily set the target number of valid mapping units of each of memory blocks, which are the target of a write operation for entering a sustained status, such that the number of valid mapping units of each of the memory blocks is within a set minimum value and a set maximum values and numbers of valid mapping units of the memory blocks have a set average value.

In some implementations, the distribution data 30 may be generated in the form of a table, and the distribution data 30 in the form of a table may include data regarding the target number of valid mapping units of each of the memory blocks that are the target of a write operation for entering a sustained status.

The sustained status acceleration module 210 may accelerate the sustained status of the storage device 10 by using the distribution data 30. Hereinafter, a method of accelerating a sustained status will be described.

First, optionally, the sustained status acceleration module 210 may generate data for the sustained status mode on its own. In some implementations, data for the sustained status mode may be test data for the sustained status mode. In some implementations, data for the sustained status mode may be generated according to a user's request or provided by the host 12 (FIG. 1).

The sustained status acceleration module 210 may perform a FILL operation of data for the sustained status mode in the buffer memory 220 based on the distribution data 30. The sustained status acceleration module 210 may perform a FLUSH operation on data stored in the buffer memory 220 to the non-volatile memory device 100. Here, the sustained status acceleration module 210 may perform a FILL operation and a FLUSH operation, thereby writing dummy data into a memory block in units of mapping units based on the distribution data 30.

In some implementations, the sustained status acceleration module 210 may generate data for the sustained status mode. Also, the sustained status acceleration module 210 may assign an arbitrary logical mapping unit number to a first data group from among the data for the sustained status mode such that entire memory blocks have the target number of corresponding valid mapping units included in the distribution data 30, and may not assign a logical mapping unit number to a second data group from among the data for the sustained status mode. Here, the logical mapping unit numbers assigned in an arbitrary order to the first data group may not overlap one another. Since logical mapping unit numbers do not overlap one another, unnecessary garbage collection operations may not be performed.

Also, data included in the second data group to which logical mapping unit numbers are not assigned from among the data for the sustained status mode may be referred to as dummy data.

Also, the sustained status acceleration module 210 may store data of the first data group, to which assigned logical mapping unit numbers are assigned, and dummy data in the buffer memory 220. Here, when data included in the first data group is stored in the buffer memory 220, not only the data but also corresponding logical mapping unit numbers may be stored.

In other words, data stored in the buffer memory 220 may be data of an arbitrary logical mapping unit number pattern including dummy data. Here, the logical mapping unit number pattern may refer to a sequence of logical mapping unit numbers that identify the location of data according to mapping with a particular physical mapping unit number. For example, the logical mapping unit number pattern may have various patterns, such as a continuous pattern, a random pattern, etc.

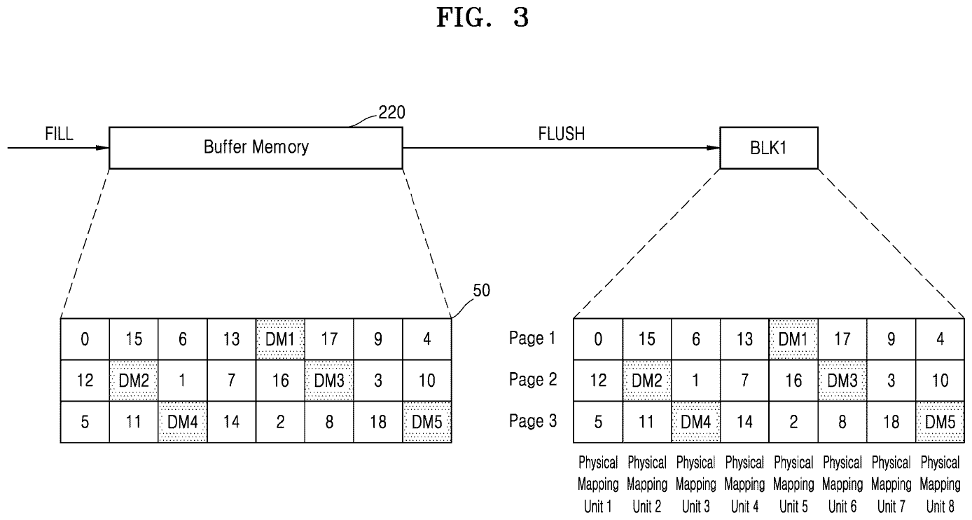

FIG. 3 is a diagram illustrating an example of a FILL operation and an example of a FLUSH operation. Referring to FIG. 3, writing dummy data into a memory block (e.g., performing a FILL operation and a FLUSH operation) in units of mapping units will be described.

Referring to FIGS. 2 and 3, the sustained status acceleration module 210 may perform a FILL operation on data indicated by up to 24 logical mapping unit numbers in the buffer memory 220, and the sustained status acceleration module 210 may perform a FLUSH operation that writes data 50 stored in the buffer memory 220 to three pages Page 1 to Page 3 of a memory block BLK1. Here, data indicated by up to eight logical mapping unit numbers may be written to one page.

In other words, referring to FIG. 3, the buffer memory 220 may store up to the size of data indicated by up to 24 logical mapping unit numbers through the FILL operation, and data stored in the buffer memory 220 may be written to three pages Page 1 to Page 3 of a memory block BLK1 through the FLUSH operation. Here, one page may include eight physical mapping units Physical Mapping Unit 1 to Physical Mapping Unit 8.

However, the present disclosure is not limited thereto, and the buffer memory 220 may perform a FLUSH operation on data indicated by any positive integer number of logical mapping unit numbers, may write data to any positive integer number of pages through a FLUSH operation, one page may include any positive integer number of physical mapping units, and the memory block BLK1 may be any memory block.

Referring to FIG. 3, the buffer memory 220 may store data 0 to 18 of the first data group assigned the logical mapping unit number described in FIG. 2 and dummy data DM1 to DM5 to which logical mapping unit numbers as described in FIG. 2 are not assigned. Here, it is shown that logical mapping unit numbers from 0 to 18 are assigned. However, the present disclosure is limited thereto, and logical mapping unit numbers from 0 to any positive integer may be assigned. Therefore, the number of the dummy data DM1 to DM5 is not limited to 5, and may vary depending on the maximum value of logical mapping unit numbers assigned thereto.

Referring to FIG. 3, through the FLUSH operation, the data 50 including data 0 to 18 assigned with logical mapping unit numbers and the dummy data DM1 to DM5 may each be mapped to one physical mapping unit. At this time, in the case of the data 50 to which a logical mapping unit number is assigned, mapping information between a corresponding logical mapping unit number and a physical mapping unit number mapped thereto may be added to a mapping table. Also, in the case of the dummy data DM1 to DM5 from among the data 50, since no logical mapping unit number is assigned thereto, there is no logical mapping unit number to be mapped to a physical mapping unit number, and thus mapping information between a logical mapping unit number (not assigned) and a physical mapping unit number mapped thereto may not be added to the mapping table. In other words, even when the dummy data DM1 to DM5 is mapped to a physical mapping unit number, a corresponding mapping information may not be added to the mapping table.

For example, referring to FIG. 3, data assigned with a logical mapping unit number of ‘15’ may be mapped to a physical mapping unit Physical Mapping Unit 2 of a page Page 1, and dummy data DM1 may be mapped to a physical mapping unit Physical Mapping Unit 5 of a page Page 1. Also, mapping information between a logical mapping unit number 15 and a physical mapping unit number Physical Mapping Unit 2 of Page 1 may be added to the mapping table, and mapping information for a physical mapping unit number Physical Mapping Unit 5 of Page 1 of the dummy data DM1 may not be added to the mapping table.

Additionally, through the FLUSH operation, the data 50 stored in the buffer memory 220 may be written to a mapped physical mapping unit. At this time, both data to which logical mapping unit numbers are assigned from among the data 50 and the dummy data DM1 to DM5 from among the data 50 may be written to the mapped physical mapping unit.

In this specification, a valid mapping unit refers to a physical mapping unit storing data to which a logical mapping unit number is assigned, and an invalid mapping unit refers to a physical mapping unit storing data to which a logical mapping unit number is not assigned (e.g., dummy data).

Referring to FIGS. 2 and 3, the data 50 stored in the buffer memory 220 may be data for a sustained status mode of an arbitrary pattern including the dummy data DM1 to DM5. Here, the data for the sustained status mode may refer to data for the sustained status mode that may be written through a single FLSH operation through the buffer memory 220 from among the entire data for the sustained status mode.

In other words, the order of logical mapping unit numbers mapped to sequential physical mapping unit numbers may be arbitrary. Also, some physical mapping unit numbers may be mapped to dummy data. Here, the logical mapping unit numbers are logical mapping unit numbers of data for the sustained status mode, which is the data 50 stored in the buffer memory 220, and the dummy data may be dummy data of data for the sustained status mode, which is the data 50 stored in the buffer memory 220.

For example, referring to FIG. 3, the order of logical mapping unit numbers 0, 15, 6, 13, 17, 9, and 4 mapped to sequential physical mapping unit numbers Physical Mapping Unit 1 to Physical Mapping Unit 8 of the page Page 1 may be arbitrary, and the physical mapping unit number Physical Mapping Unit 5 of the page Page 1 may be mapped to the dummy data DM1 to which no logical mapping unit number is assigned.

In some implementations, data for the sustained status mode may be sequentially stored in the buffer memory 220. At this time, logical mapping unit numbers assigned to the data for the sustained status mode that is sequentially stored may be arbitrary, and some data may not be assigned with a logical mapping unit number. For example, referring to FIG. 3, first stored data may be assigned ‘0’, second stored data may be assigned with ‘15’, third stored data may be assigned with ‘6’, fourth stored data may be assigned with ‘13’, fifth stored data may not be assigned with a logical mapping unit number, sixth stored data may be assigned with ‘17’, seventh stored data may be assigned with ‘9’, and eighth stored data may be assigned with ‘4’. Here, the fifth stored data may not be assigned with a logical mapping unit number. At this time, the fifth stored data may be the dummy data DM1. In some implementations, data for the sustained status mode may also be stored in the buffer memory 220 at once. Even when stored at once, the mapping order of logical mapping unit numbers and physical mapping unit numbers may be arbitrary, and some physical mapping units may be mapped to dummy data.

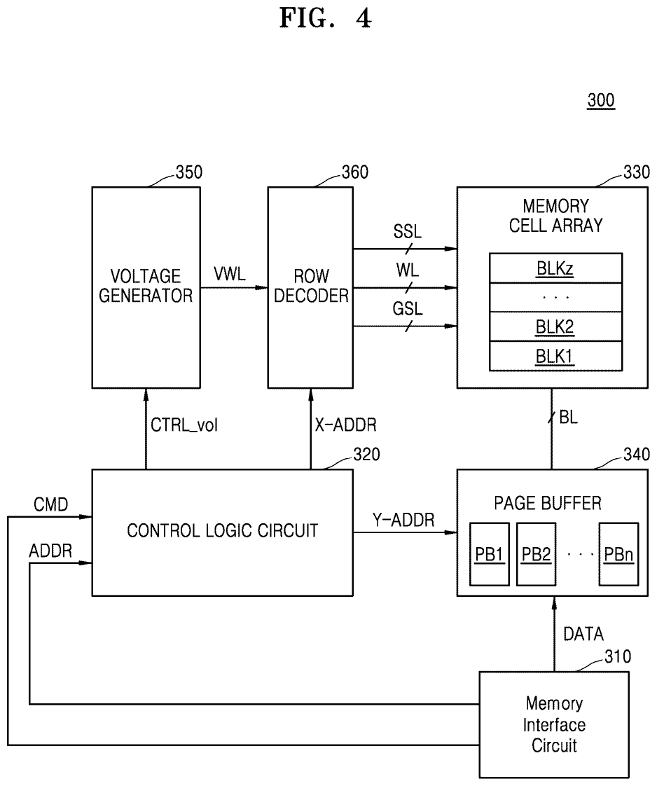

FIG. 4 is a block diagram showing an example of one non-volatile memory device (NVM). A non-volatile memory device 300 may correspond to one of the at least one non-volatile memory device 100 described in FIG. 2. Hereinafter, descriptions will be given with reference to FIGS. 1 to 3, and repeated descriptions will be omitted.

Referring to FIG. 4, the non-volatile memory device 300 may include a memory interface circuit 310, a control logic circuit 320, a memory cell array 330, a page buffer 340, a voltage generator 350, and a row decoder 360. Although not shown in FIG. 1, the non-volatile memory device 300 may further include a column logic, a pre-decoder, a temperature sensor, a command decoder, an address decoder, etc.

The control logic circuit 320 may overall control various operations inside the non-volatile memory device 300. The control logic circuit 320 may output various control signals in response to a command CMD and/or an address ADDR from the memory interface circuit 310. For example, the control logic circuit 320 may output a voltage control signal CTRL_vol, a row address X-ADDR, and a column address Y-ADDR.

The memory cell array 330 may include a plurality of memory blocks BLK1 to BLKz (z is a positive integer), and the plurality of memory blocks BLK1 to BLKz may each include a plurality of memory cells. The memory cell array 330 may be connected to the page buffer 340 through bit lines BL and may be connected to the row decoder 360 through word lines WL, string select lines SSL, and ground select lines GSL. Here, the sector described in FIG. 2 may include a plurality of memory cells.

In other words, referring to FIGS. 2 and 3, the non-volatile memory device 100 or 300 may include a plurality of memory blocks BLK1 to BLKz (z is an integer greater than or equal to 2). The plurality of memory blocks BLK1 to BLKz may each include a plurality of pages Page 1 to Page m (m is an integer greater than or equal to 2). The plurality of pages Page 1 to Page m may each include a plurality of physical mapping units Physical Mapping Unit 1 to Physical Mapping Unit s (s is an integer greater than or equal to 2). The plurality of physical mapping units Physical Mapping Unit 1 to Physical Mapping Unit n may each include a plurality of sectors Sector 1 to Sector t (t is an integer greater than or equal to 2). The plurality of sectors Sector 1 to Sector t (t is an integer greater than or equal to 2) may include a plurality of memory cells.

In some implementations, the memory cell array 330 may include a 3-dimensional memory cell array, and the 3-dimensional memory cell array may include a plurality of NAND strings. Each NAND string may include memory cells connected to word lines vertically stacked on a substrate, respectively. U.S. Pat. Nos. 7,679,133, 8,553,466, 8,654,587, 8,559,235, and U.S. Patent Application Publication No. 2011/0233648 are incorporated herein by reference. In some implementations, the memory cell array 330 may include a 2-dimensional memory cell array, and the 2-dimensional memory cell array may include a plurality of NAND strings arranged in row-wise directions and column-wise directions.

The page buffer 340 may include a plurality of page buffers PB1 to PBn (n is an integer greater than or equal to 3), and the plurality of page buffers PB1 to PBn may be respectively connected to memory cells through the plurality of bit lines BL. The page buffer 340 may select at least one bit line BL from among the bit lines BL in response to a column address Y-ADDR. The page buffer 340 may operate as a write driver or a sense amplifier depending on an operation mode. For example, during a program operation, the page buffer 340 may apply a bit line voltage corresponding to data to be programmed to a selected bit line. During a read operation, the page buffer 340 may sense data stored in a memory cell by sensing a current or a voltage of the selected bit line.

The voltage generator 350 may generate various types of voltages for performing a program operation, a read operation, and an erase operation based on a voltage control signal CTRL_vol. For example, the voltage generator 350 may generate a program voltage, a read voltage, a program verify voltage, or an erase voltage as a word line voltage VWL.

The row decoder 360 may select one from among the word lines WL in response to a row address X-ADDR and may select one from among the string select lines SSL. For example, the row decoder 360 may apply a program voltage and a program verify voltage to a selected word line during a program operation and may apply a read voltage to a selected word line during a read operation.

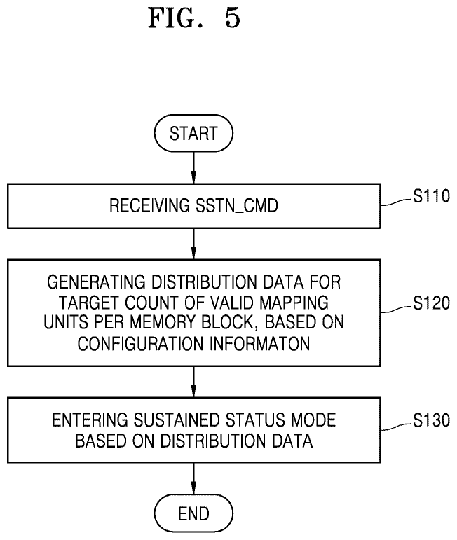

FIG. 5 is a flowchart showing an example a method of accelerating a sustained status of a storage device. Referring to FIGS. 1 to 5, a method of accelerating a sustained status of the storage device 10 will be described.

In operation S110, the storage device 10 may receive a sustained status command SSTN_CMD. At this time, the storage device 10 may receive the sustained status command SSTN_CMD from the host 12 or from the outside.

In operation S120, the storage device 10 may generate the distribution data 30 for a target number of valid mapping units per memory block within the storage device 10 based on the configuration information 20 for the sustained status mode in response to the sustained status command SSTN_CMD. At this time, configuration information 20 for the sustained status mode may be included in the sustained status command SSTN_CMD.

In operation S130, the storage device 10 may enter a sustained status mode based on the distribution data 30 for a target number of valid mapping units per memory block within the storage device 10. Also, the storage device 10 may enter the sustained status mode by writing dummy data into a memory block in units of mapping units based on the distribution data 30 for the target number of valid mapping units per memory block.

Here, the distribution data 30 for the target number of valid mapping units per memory block may correspond to a set of the number of valid mapping units per memory block for the entire memory block that is the target of a write operation to enter the sustained status mode by the sustained status command SSTN_CMD. Also, the number of valid mapping units per memory block of the entire memory block may be greater than or equal to a pre-set reference number, and thus the storage device 10 may enter the sustained status.

In other words, the sustained status mode is a state in which the storage device 10 operates in a sustained status by the sustained status command SSTN_CMD, and may indicate a state in which the number of valid mapping units of each of the memory blocks in the storage device 10 is greater than or equal to a reference number in response to the sustained status command SSTN_CMD. Also, according to the present disclosure, a sustained status mode for accelerating the sustained status may refer to a state in which the number of valid mapping units of memory blocks in a storage device corresponds to a target number of pieces of generated distribution data.

In other words, in a general storage device, to enter a sustained status, a write operation is performed for several hours or days while sequentially or randomly changing a data access pattern, but the storage device 10 according to the present disclosure may quickly enter a sustained status mode without performing a garbage collection operation, in response to the sustained status command SSTN_CMID.

FIG. 6 is a flowchart illustrating an example operation S120 of the method of accelerating a sustained status of a storage device in more detail.

Referring to FIG. 6, operation S120 may include operations S121, S123, S125, and S127.

The configuration information 20 regarding the sustained status mode may be included in the sustained status command SSTN_CMD. The configuration information 20 regarding the sustained status mode is the minimum information for the storage device 10 to enter the sustained mode, and may include, for example, the total number of valid mapping units to be used in the sustained status mode, the number of memory blocks to be allocated to user data, the total number of memory blocks, the number of system blocks and minimum free blocks that need to be maintained for normal operation of firmware, the mapping size, the internal structure of a memory, the LBA format, and/or the firmware policy.

In operation S121, the storage device 10 may set an average value of the number of valid mapping units per memory block in the sustained status mode based on the number of total valid mapping units to be used in the sustained status mode and the number of memory blocks to be assigned to user data. Here, the user data may represent data that a user (e.g., the host 12) writes and reads as needed.

In some implementations, the storage device 10 may derive an average value of the number of valid mapping units per memory block in the sustained status mode by dividing the number of total valid mapping units to be used in the sustained status mode by the number of memory blocks to be assigned to user data.

Also, in some implementations, when the number of memory blocks to be assigned to user data is not provided by the configuration information 20 for the sustained status mode, the storage device (10) may derive the number of memory blocks to be allocated to user data based on the total number of memory blocks in the storage device 10 and the number of system blocks and the minimum number of free blocks that need to be maintained by firmware for normal performance.

Here, system data is the minimum data needed for internal management and operation of the storage device 10, and may represent data used in the firmware of the storage device 10 to support user data and ensure stable operation of the storage device 10. For example, the system data may include mapping data, wear-leveling data, error correction code (ECC), and garbage collection (GC) related data.

For example, the storage device 10 may set an average value of the number of valid mapping units per memory block in the sustained status mode based on Equation 1 below.

$$AVG\_VMC = \frac{TOTAL\_VMC \_SSTN}{N\_B - N\_FB} \qquad [ Equation 1 ]$$

Here, AVG_VMC may represent the average value of the number of valid mapping units per memory block in the sustained status mode, TOTAL_VMC_SSTN may represent the total number of valid mapping units to be used in the sustained status mode, N_B may represent the total number of memory blocks, and N_FB may represent the number of system blocks and the minimum number of free blocks that need to be maintained by the firmware to perform normally.

In other words, the storage device 10 may set an average value of the number of valid mapping units per memory block in the sustained status mode by subtracting the number of system blocks and the minimum number of free blocks that need to be maintained by firmware for normal operation from the total number of memory blocks and dividing the total number of valid mapping units to be used in the sustained status mode by a result of the subtraction. Here, the result of the subtraction may correspond to the number of memory blocks to be assigned to user data.

In operation S123, the storage device 10 may set the maximum number of valid mapping units per memory block in the sustained status mode based on the mapping size and the internal structure of a memory. Here, the mapping size may represent the size used to define the mapping between a logical address and a physical address. Also, the internal structure of the memory may represent a page size, a block size, the number of memory cells, etc.

In some implementations, the storage device 10 may set the maximum number of valid mapping units per memory block in the sustained status mode based on the mapping size, the LBA format, the internal structure of the memory, and/or the firmware policy.

Here, the LBA format is a method of assigning a logical address of data, and may indicate specifications on how to map data to physical addresses. According to the LBA format, the size and the layout of pages or blocks may vary. Also, the firmware policy is a policy of firmware that manages the operation of the storage device 10, and may be a policy regarding, for example, wear-leveling, GC, etc.

Also, in the sustained status mode, the maximum value of the number of valid mapping units per memory block may correspond to the number of valid mapping units when all physical mapping units assigned to user data of one memory block are valid (i.e., there is no dummy data that is not assigned with a logical mapping number).

Meanwhile, operation S121 and operation S123 may be performed simultaneously, and operation S121 and operation S123 may not be limited to a particular order.

In operation S125, the storage device 10 may set a minimum value of the number of valid mapping units per memory block in the sustained status mode based on the average value set in operation S121 and the maximum value set in operation S123.

For example, the storage device 10 may set a minimum value of the number of valid mapping units per memory block in the sustained status mode based on Equation 2 below.

$$\begin{matrix}MIN\_VMC = AVG\_VMC - ( MAX\_VMC - AVG\_VMC ) \\ = 2 AVG\_VMC - MAX\_VMC\end{matrix} \qquad [ Equation 2 ]$$

Here, AVG_VMC may represent the average value of the number of valid mapping units per memory block in the sustained status mode, and MAX_VMC may represent the maximum value of the number of valid mapping units per memory block in the sustained status mode.

In other words, the storage device 10 may set the minimum value of the number of valid mapping units per memory block in the sustained status mode by subtracting the difference between the maximum value and the average value from the average value.

In operation S127, the storage device 10 may arbitrarily generate the distribution data 30 for the target number of valid mapping units per memory block, such that the target number of valid mapping units per memory block within the storage device 10 conforms to a set minimum value, a set maximum value, and an average value. Here, the distribution data 30 may correspond to a set of the number of valid mapping units per memory block for the memory block that is the target of a write operation to enter a sustained status.

In other words, the storage device 10 may arbitrarily set the target number of valid mapping units of each of memory blocks, which are the target of a write operation for entering a sustained status, such that the number of valid mapping units of each of the memory blocks is within a set minimum value and a set maximum values and numbers of valid mapping units of the memory blocks have a set average value.

In some implementations, the distribution data 30 may be generated in the form of a table, and the distribution data 30 in the form of a table may include data regarding the target number of valid mapping units of each of the memory blocks that are the target of a write operation for entering a sustained status.

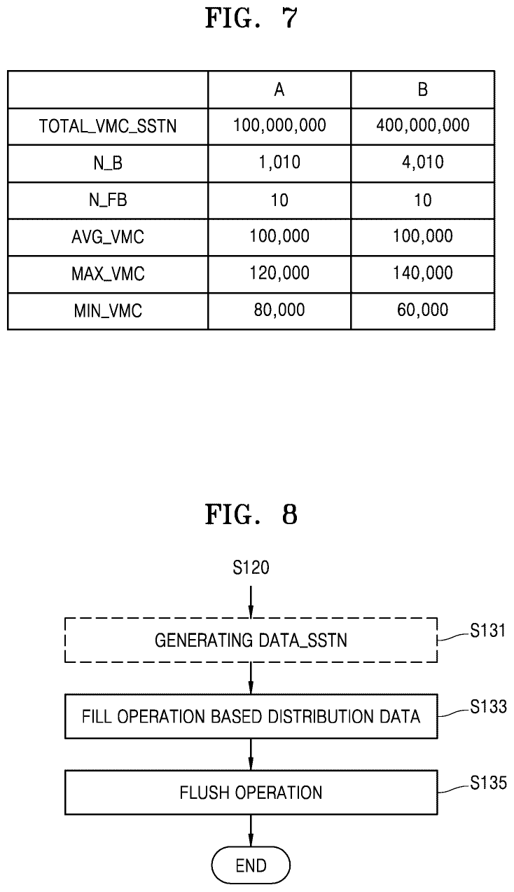

FIG. 7 is a diagram showing an example of a method of setting an average value, a maximum value, and a minimum value of a target number of valid mapping units per memory block.

FIG. 7 is a diagram showing average, maximum, and minimum values of the target number of valid mapping units per memory block set by the storage device 10 based on the configuration information regarding the sustained status mode for two cases A and B.

Referring to FIG. 7, in the case A, the total number TOTAL_VMC_SSTN of valid mapping units to be used in the sustained status mode is 100,000,000, the total number of memory blocks N_B is 1,010, and the number of system blocks and the minimum number of free blocks N_FB needed by firmware to maintain for normal operation is 10. According to Equation 1 described in FIG. 6, an average value AVG_VMC of the number of valid mapping units per memory block in the sustained status mode may be set to 100,000 (100,000,000/(1010−10)). Also, a maximum number MAX_VMC of valid mapping units per memory block in the sustained status mode may be set to 120,000, based on the mapping size (e.g., 16 KB) and the internal structure of a memory. Also, according to Equation 2 described in FIG. 6, a minimum value MIN_VMC of the number of valid mapping units per memory block in the sustained status mode may be set to 80,000 (2*100,000−120,000).

Referring to FIG. 7, in the case B, the total number TOTAL_VMC_SSTN of valid mapping units to be used in the sustained status mode is 400,000,000, the total number of memory blocks N_B is 4,010, and the number of system blocks and the minimum number of free blocks N_FB needed by firmware to maintain for normal operation is 10. According to Equation 1 described in FIG. 6, the average value AVG_VMC of the number of valid mapping units per memory block in the sustained status mode may be set to 100,000 (400,000,000/(4010−10)). Also, the maximum number MAX_VMC of valid mapping units per memory block in the sustained status mode may be set to 140,000, based on the mapping size (e.g., 4 KB) and the internal structure of a memory. Also, according to Equation 2 described in FIG. 6, the minimum value MIN_VMC of the number of valid mapping units per memory block in the sustained status mode may be set to 60,000 (2*100,000−140,000).

FIG. 8 is a flowchart illustrating an example operation S130 of the method of accelerating a sustained status of a storage device in more detail.

Referring to FIG. 8, operation S130 may include operations S131, S133, and S135.

In operation S131, the storage device 10 may generate data for the sustained status mode on its own. Since the storage device 10 generates data for the sustained status mode on its own, entry into the sustained status mode of the storage device 10 may be implemented by an internal operation of the memory controller 200.

Meanwhile, operation S131 may be performed optionally. In some implementations, data for the sustained status mode may be test data for the sustained status mode. In some implementations, data for the sustained status mode may be generated according to a user's request or provided by the host 12 (FIG. 1).

In operation S133, the storage device 10 may perform a FILL operation to store data for the sustained status mode in the buffer memory 220 based on the distribution data 30. Here, the data for the sustained status mode may refer to data for the sustained status mode that may be written through a single FLSH operation through the buffer memory 220 from among the entire data for the sustained status mode.

Also, in operation S133, the storage device 10 may assign a logical mapping unit number to a first data group from among the data for the sustained status mode in an arbitrary sequence such that entire memory blocks have the target number of corresponding valid mapping units included in the distribution data 30, and may not assign a logical mapping unit number to a second data group from among the data for the sustained status mode. Here, the logical mapping unit numbers assigned in an arbitrary order to the first data group may not overlap one another. Since logical mapping unit numbers do not overlap one another, unnecessary garbage collection operations may not be performed.

Also, data included in the second data group to which logical mapping unit numbers are not assigned from among the data for the sustained status mode may be referred to as dummy data.

In operation S135, the storage device 10 may perform a FLUSH operation to write data for the sustained status mode stored in the buffer memory 220 to a corresponding memory block.

As described above, by performing of the FILL operation in operation S133 and the FLUSH operation in operation S135, the storage device 10 may write dummy data from among the data for the sustained status mode into a memory block in units of mapping units based on the distribution data 30.

Operations S133 and S135 may be repeated until all memory blocks have the target number of corresponding valid mapping units included in the distribution data 30.

When all memory blocks have the target number of corresponding valid mapping units included in the distribution data 30, the storage device 10 may be considered to have reached the sustained status.

According to the present disclosure, entry of the storage device 10 into the sustained status mode may be implemented by the internal operation of the memory controller 200. In other words, since there is no data exchanged with the host 12 (FIG. 1) other than the sustained status command SSTN_CMD of the host 12 (FIG. 1) when the storage device 10 enters the sustained status mode, the storage device 10 according to the present disclosure may enter the sustained status mode with a constant performance regardless of the performance of the host 12 (FIG. 1).

According to the present disclosure, unlike the entry to the sustained status by the host workload or the firmware of the host 12, the entry to the sustained status according to the present disclosure does not rely on the host workload or the firmware of the host 12. Therefore, the memory controller 200 according to the present disclosure may be universally utilized in a storage device.

According to the present disclosure, entry to the sustained status mode of the storage device 10 may be implemented as an internal operation of the memory controller 200 without the need to extract a sustained valid page count or a valid mapping unit count from another storage device.

According to the present disclosure, since entry to the sustained status mode of the storage device 10 is performed inside the memory controller 200, the storage device 10 may write dummy data to a memory block in units of mapping units rather than in units of pages.

In the sustained status mode of the storage device 10 according to the present disclosure, dummy data is written to a memory block in units of mapping units rather than in units of pages, and thus the sustained status formed by the storage device 10 is more similar to a sustained status formed in an actual user environment than sustained status mode in units of pages. Therefore, the accuracy of a test result regarding the storage device 10 in the sustained status mode may be improved.

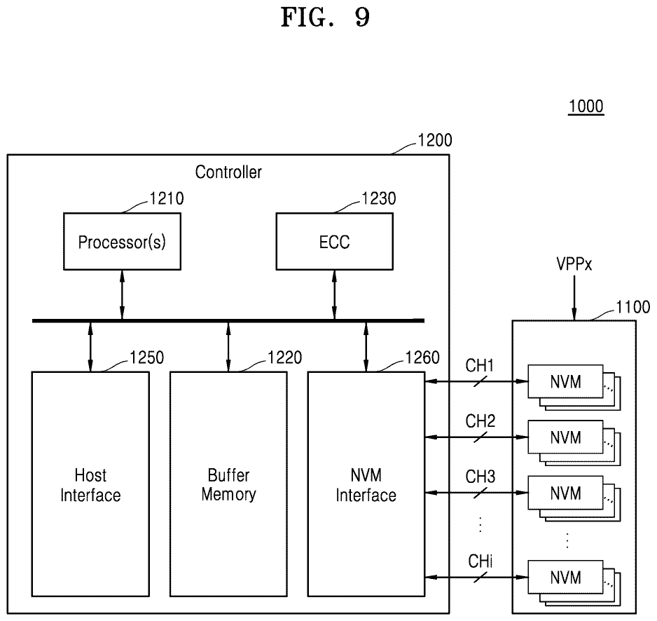

FIG. 9 is a block diagram showing an example of a solid state drive (SSD). The storage device 10 according to the present disclosure is applicable to an SSD.

Referring to FIG. 9, an SSD 1000 may include a plurality of non-volatile memory devices 1100 and an SSD controller 1200.

The non-volatile memory devices 1100 may optionally be implemented to receive an external high voltage Vpp. The non-volatile memory devices 1100 may each be implemented with the non-volatile memory device 100 described in FIG. 2.

The SSD controller 1200 may be connected to the non-volatile memory devices 1100 through a plurality of channels CH1 to CHi (i is an integer greater than or equal to 2). The SSD controller 1200 may be implemented with the memory controller 200 shown in FIG. 2.

The SSD controller 1200 may include at least one processor 1210, the buffer memory 1220, an error correction circuit 1230, a host interface 1250, and a non-volatile memory interface 1260.

The buffer memory 1220 may temporarily store data needed for the operation of the SSD controller 1200. The buffer memory 1220 may be implemented with the buffer memory 220 shown in FIG. 2.

In FIG. 9, the buffer memory 1220 is located inside the SSD controller 1200, but the present disclosure is not limited thereto. The buffer memory 1220 according to the present disclosure may be located outside the SSD controller 1200.

The error correction circuit 1230 may calculate an error correction code value of data to be programmed in a write operation, correct errors in data read in a read operation based on the error correction code value, and correct errors in data recovered from non-volatile memory devices 1100 in a data recovery operation.

The error correction circuit 1230 may generate an error correction code (ECC) to correct a fail bit or an error bit of data received from the non-volatile memory devices 1100. The error correction circuit 1230 may perform error correction encoding of data provided to the non-volatile memory devices 1100 to form data with parity bits added. The parity bits may be stored in the non-volatile memory devices 1100. Also, the error correction circuit 1230 may perform error correction decoding on data output from the non-volatile memory devices 1100.

The error correction circuit 1230 may correct errors by using parity. The error correction circuit 1230 may correct errors by using coded modulation such as low density parity check (LDPC) code, BCH code, turbo code, Reed-Solomon code, convolution code, recursive systematic code (RSC), trellis-coded modulation (RCM), and block coded modulation (BCM).

Although not shown, a code memory may be further included to store code data needed to operate the SSD controller 1200. The code memory may be implemented with a non-volatile memory device.

The host interface 1250 may provide interface functions with external devices. The host interface 1250 may be connected to the host via a parallel AT attachment (PATA) bus, a serial AT attachment (SATA) bus), a SCSI, a USB, a PCie, an SD, an SAS, a universal flash storage (UFS), a NAND interface, etc.

The non-volatile memory interface 1260 may provide an interface function with the non-volatile memory devices 1100.

The SSD 1000 may enter a sustained status mode in response to a sustained status command SSTN_CMD, as described in FIGS. 1 to 8.

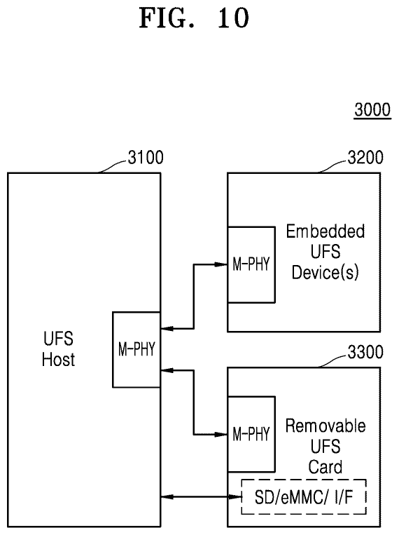

FIG. 10 is a block diagram showing an example of a UFS system. The storage device 10 according to the present disclosure may also be applied to a UFS.

Referring to FIG. 10, a UFS system 3000 may include a UFS host 3100, at least one embedded UFS device 3200, and a removable UFS card 3300. Communication between the UFS host 3100 and the embedded UFS device 3200 and communication between the UFS host 3100 and the removable UFS card 3300 may be performed through an M-PHY layer.

At least one of the embedded UFS device 3200 and the removable UFS card 3300 may be implemented with the storage device 10 shown in FIG. 1.

Meanwhile, the UFS host 3100 and the removable UFS card 3300 may be equipped with a bridge to communicate each other through a protocol other than a UFS protocol. The UFS host 3100 and the removable UFS card 3300 may communicate with each other via various card protocols (e.g., UFDs, MMC, eMMC secure digital (SD), mini SD, Micro SD, etc.).

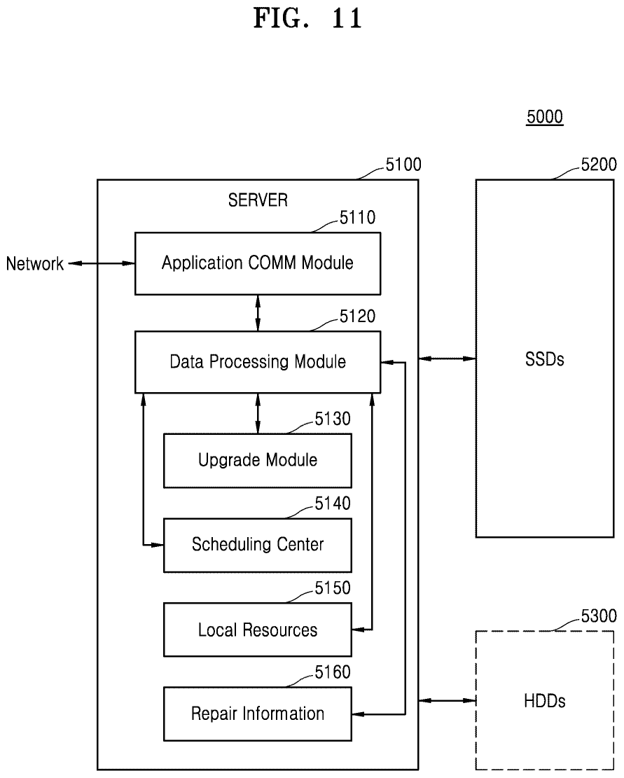

FIG. 11 is a block diagram showing an example of a data server system 5000. The storage device 10 according to the present disclosure is applicable to a data server system.

Referring to FIG. 11, the data server system 5000 may include a server 5100 and a plurality of SSDs 5200 that store data required to operate the server 5100. Here, the SSDs 5200 may be implemented with the same configuration and the operation as those of the storage device 10 shown in FIG. 1.

The server 5100 may include an application communication module 5110, a data processing module 5120, an upgrade module 5130, a scheduling center 5140, a local resource module 5150, and a repair information module 5160. The application communication module 5110 is implemented to communicate with a computing system connected to the server 5100 and a network, or to enable communication between the server 5100 and the SSDs 5200. The application communication module 5110 may transmit authorized data or information to the data processing module 5120 through a user interface. The data processing module 5120 may be linked to the local resource module 5150. Here, the local resource module 5150 may provide a list of repair shops/dealers/technical information to a user based on data or information input into the server 5100.

The upgrade module 5130 may interface with the data processing module 5120. The upgrade module 5130 may upgrade firmware, reset code, diagnostic system upgrade or other information to an appliance based on data or information transmitted from the SSDs 5200. The scheduling center 5140 may allow real-time options to a user based on data or information input into the server 5100.

The repair information module 5160 may interface with the data processing module 5120. The repair information module 5160 may be used to authorize a user to receive repair-related information (e.g., audio, video, or document files). The data processing module 5120 may package related information based on information transmitted from the SSDs 5200. The information may then be transmitted to the SSDs 5200 or displayed to a user.

In some implementations, hard disk drives (HDDs) 5300 may optionally be connected to the server 5100.

The data server system 5000 may improve the reliability of data stored in a data server by quickly performing a test of a sustained status at any time and quickly replacing a storage device according to a result of the test.

A storage system or storage device may be mounted by using various types of packages. In some implementations, a storage system or a storage device may be mounted by using packages like package-on-package (PoP), ball grid arrays (BGAs), chip scale packages (CSPs), a plastic leaded chip carrier (PLCC), a plastic dual in-line package (PDIP), a die in waffle pack, a die in wafer form, a chip-on-board (COB), a ceramic dual in-line package (CERDIP), a plastic metric quad flat pack (MQFP), a thin quad flat pack (TQFP), a small outline (SOIC), a shrink small outline package (SSOP), a thin small outline (TSOP), a system in package (SIP), a multi chip package (MCP), a wafer-level fabricated package (WFP), a wafer-level processed stack package (WSP), etc.

Meanwhile, the storage devices described above may be applied to various mobile devices such as smart phones, wearable watches, and smart glasses.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While the present disclosure has been shown and described with reference to implementations thereof, it will be understood that various changes in form and details may be made therein without departing from the spirit and scope of the following claims.

What is claimed is:

1. A method of accelerating a sustained status of a storage device, the storage device comprising a non-volatile memory comprising a plurality of memory blocks and a memory controller configured to control the non-volatile memory, the method comprising:
receiving a sustained status command, wherein the sustained status command comprises configuration information for a sustained status mode;
based on the configuration information, generating distribution data for a target number of valid mapping units per memory block in the non-volatile memory; and
based on the distribution data, writing dummy data into a plurality of mapping units in a memory block and entering into a sustained status mode,
wherein the sustained status mode indicates a state in which an actual number of valid mapping units of the plurality of memory blocks corresponds to a target number of pieces of the distribution data.

2. The method of claim 1, wherein the configuration information specifies a number of total valid mapping units to be used in the sustained status mode, a number of memory blocks to be assigned to user data, and a mapping size, and
wherein generating the distribution data comprises:
setting, based on the number of total valid mapping units to be used in the sustained status mode and the number of memory blocks to be assigned to user data, an average value of valid mapping units per memory block in the sustained status mode; and
setting, based on the mapping size and a memory structure, a maximum value of valid mapping units per memory block in the sustained status mode.

3. The method of claim 2, wherein generating the distribution data comprises setting, based on the average value and the maximum value, a minimum value of valid mapping units per memory block in the sustained status mode.

4. The method of claim 3, wherein, as a result of generating the distribution data, the target number of valid mapping units per memory block satisfies the minimum value, the maximum value, and the average value.

5. The method of claim 3, wherein setting the minimum value comprises subtracting a difference between the maximum value and the average value from the average value.

6. The method of claim 1, wherein the memory controller comprises a buffer memory,
wherein entering into the sustained status mode comprises:
storing, during a FILL operation, data for the sustained status mode in the buffer memory based on the distribution data; and
writing, during a FLUSH operation and to a first memory block, the data for the sustained status mode stored in the buffer memory, and
wherein the FILL operation comprises assigning a plurality of logical mapping unit numbers to a plurality of data groups among the data for the sustained status mode, such that the plurality of memory blocks have the target number of valid mapping units included in the distribution data.

7. The method of claim 6, wherein the data for the sustained status mode stored in the buffer memory comprises the dummy data, and
wherein the dummy data comprises data that is without an assigned logical mapping unit number during the FILL operation.

8. The method of claim 6, wherein entering into the sustained status mode comprises generating the data for the sustained status mode.

9. A storage device comprising:
a non-volatile memory comprising a plurality of memory blocks; and
a memory controller configured to control the non-volatile memory,
wherein the memory controller is configured to
receive a sustained status command, wherein the sustained status command comprises configuration information for a sustained status mode,
based on the configuration information, generate distribution data for a target number of valid mapping units per memory block of the plurality of memory blocks, and
based on the distribution data, write dummy data into the non-volatile memory in a plurality of mapping units and cause the non-volatile memory to enter the sustained status mode, and
wherein the sustained status mode indicates a state in which an actual number of valid mapping units of the plurality of memory blocks corresponds to a target number of pieces of the distribution data.

10. The storage device of claim 9, wherein the configuration information comprises a number of total valid mapping units to be used in the sustained status mode, a number of memory blocks to be assigned to user data, and a mapping size, and
wherein the memory controller is configured to
set, based on the number of total valid mapping units to be used in the sustained status mode and the number of memory blocks to be assigned to user data, an average value of valid mapping units per memory block in the sustained status mode, and
set, based on the mapping size and a memory structure, a maximum value of valid mapping units per memory block in the sustained status mode.

11. The storage device of claim 10, wherein the memory controller is configured to set, based on the average value and the maximum value, a minimum value of valid mapping units per memory block in the sustained status mode.

12. The storage device of claim 11, wherein the memory controller is configured to generate the distribution data such that the target number of valid mapping units per memory block satisfies the minimum value, the maximum value, and the average value.

13. The storage device of claim 11, wherein the memory controller is configured to set the minimum value by subtracting a difference between the maximum value and the average value from the average value.

14. The storage device of claim 9, wherein the memory controller comprises a buffer memory,
wherein the memory controller is configured to
store, during a FILL operation, data for the sustained status mode in the buffer memory based on the distribution data, and
write, during a FLUSH operation and to a first memory block, data for the sustained status mode stored in the buffer memory, and
wherein the memory controller is configured to assign a plurality of logical mapping unit numbers to a plurality of data groups among the data for the sustained status mode, such that the plurality of memory blocks have the target number of valid mapping units included in the distribution data.

15. The storage device of claim 14, wherein the data for the sustained status mode stored in the buffer memory comprises the dummy data, and
wherein the dummy data is without an assigned logical mapping unit number.

16. The storage device of claim 14, wherein the memory controller is configured to generate the data for the sustained status mode.

17. A memory controller for controlling at least one non-volatile memory, wherein the at least one non-volatile memory comprises a plurality of memory blocks, and wherein the memory controller comprises a sustained status acceleration circuit,
wherein the sustained status acceleration circuit is configured to
receive a sustained status command comprising configuration information for a sustained status mode,
generate, based on the configuration information, distribution data for a target number of valid mapping units per memory block in the non-volatile memory, and
write, based on the distribution data, dummy data into a plurality of mapping units in the non-volatile memory and cause the non-volatile memory to enter the sustained status mode, and
wherein the sustained status mode indicates a state in which a number of valid mapping units of the plurality of memory blocks corresponds to a target number of pieces of the distribution data.

18. The memory controller of claim 17, wherein the configuration information comprises a number of total valid mapping units to be used in the sustained status mode, a number of memory blocks to be assigned to user data, and a mapping size, and wherein the sustained status acceleration circuit is configured to
set, based on the number of total valid mapping units to be used in the sustained status mode and the number of memory blocks to be assigned to user data, an average value of valid mapping units per memory block in the sustained status mode, and
set, based on the mapping size and a memory structure, a maximum value of valid mapping units per memory block in the sustained status mode.

19. The memory controller of claim 18, wherein the sustained status acceleration circuit is configured to set, based on the average value and the maximum value, a minimum value of valid mapping units per memory block in the sustained status mode.

20. The memory controller of claim 19, wherein the sustained status acceleration circuit is configured to generate the distribution data, such that the target number of valid mapping units per memory block satisfies the minimum value, the maximum value, and the average value.
